(19) United States
(12) Patent Application Publication
(10) Pub. No.: US 2025/0309945 A1
(43) Pub. Date: Oct. 2, 2025

(54) DEVICES AND METHODS FOR CHANNEL ESTIMATION IN AN IRS ASSISTED WIRELESS NETWORK

(71) Applicant: HUAWEI TECHNOLOGIES CO., LTD., Shenzhen (CN)

(72) Inventors: Malte SCHELLMANN, Munich (DE); Samer BAZZI, Munich (DE)

(73) Assignee: HUAWEI TECHNOLOGIES CO., LTD., Shenzhen (CN)

(21) Appl. No.: 19/236,061

(22) Filed: Jun. 12, 2025

Related U.S. Application Data
(63) Continuation of application No. PCT/EP2022/085825, filed on Dec. 14, 2022.

(51) Int. Cl. H04B 7/04; H04L 5/00; H04L 25/02

(52) U.S. Cl. CPC H04B 7/04013; H04L 5/0051; H04L 25/0248

(57) ABSTRACT

A user equipment (UE) for communication with a base station over a communication channel via an intelligent reflective surface (IRS. The UE is configured to control the IRS to operate with a plurality of reflection configurations for reflecting a plurality of pilot signals sent from the base station to the UE for probing the channel between the base station, IRS, and the UE. The plurality of reflection configurations of the IRS includes a first plurality of reflection configurations for estimating, by the UE, a channel covariance matrix, (CCM) of the communication channel between the base station and the UE via the IRS, and a second plurality of reflection configurations for estimating, by the UE, the communication channel between the base station and the UE via the IRS.

### CROSS-REFERENCE TO RELATED APPLICATIONS

This application is a continuation of International Application No. PCT/EP2022/085825, filed on Dec. 14, 2022, the disclosure of which is hereby incorporated by reference in its entirety.

### TECHNICAL FIELD

The embodiments relate to wireless communication networks, and to devices and methods for channel estimation controlled at least partially by a user equipment in a wireless network assisted by an intelligent reflecting surface (IRS).

### BACKGROUND

Intelligent reflecting surfaces (IRSs) have the potential to shape the channel environment in a wireless network according to desired conditions. An IRS is a planar array having a large number of (nearly) passive, low-cost and low energy consuming reflecting elements with reconfigurable parameters. Each of these elements is configured to reflect an impinging radio wave with an individually configurable phase shift (and optionally, an individually configurable amplitude), which results in the formation of a reflection beam, whose direction can be actively controlled by choosing the phase shifts for the reflecting elements accordingly. One or multiple IRSs can be easily integrated into walls or ceilings of large halls and buildings.

IRSs can be used in wireless communications for different purposes, such as for indoor and industrial IoT communications, where IRSs can support focusing the transmit power into the direction of low-power user equipment (UEs) and—in a favorable case—establishing LOS-like communication links to them. Typically, an IRS has several hundred antenna elements, enabling the formation of highly directive and focused beams and yielding high antenna gains. Reflection beams are formed by (predefined) sets of phase shifts (and optionally, sets of amplitudes) applied to the antenna elements, which can be configured and controlled by a base station, e.g. a gNB. For this purpose, an IRS may house a controller, which is directly connected to that base station.

### SUMMARY

It is an objective of the embodiments to provide improved devices and methods for channel estimation in a wireless network, including a cellular network using an intelligent reflecting surface (IRS).

Further implementation forms of the embodiments are apparent from the description and the figures.

According to a first aspect, a user equipment, (UE) for communication with a base station over a communication channel via an intelligent reflective surface (IRS) is provided. The UE is configured to control the IRS to operate with a plurality of reflection configurations for reflecting a plurality of pilot signals sent from the base station to the UE for probing the channel between base station, IRS, and the UE. The plurality of reflection configurations of the IRS includes a first plurality of reflection configurations for estimating by the UE a channel covariance matrix (CCM) of the communication channel between the base station and the UE via the IRS, and a second plurality of reflection configurations for estimating by the UE the communication channel between the base station and the UE via the IRS. While the first plurality of reflection configurations of the IRS allows providing a first rough estimate of the channel conditions, the second plurality of reflection configurations of the IRS allows determining a more accurate estimate of the communication channel.

In a further possible implementation form of the first aspect, the UE is configured to determine the CCM based on the plurality of received pilot signals from the base station reflected by the IRS with the first plurality of reflection configurations.

In a further possible implementation form of the first aspect, the UE is configured to determine the second plurality of reflection configurations based on the CCM.

In a further possible implementation form of the first aspect, the UE is configured to determine the second plurality of reflection configurations based on a plurality of eigenvectors of the CCM.

In a further possible implementation form of the first aspect, the UE is configured to determine the second plurality of reflection configurations based on a plurality of eigenvectors of the CCM having the largest eigenvalues.

In a further possible implementation form of the first aspect, the UE is configured to update the CCM based on the plurality of received pilot signals from the base station reflected by the IRS with the first plurality of reflection configurations. The UE may be configured to update the second plurality of reflection configurations based on an updated CCM, if a value of a difference measure between the updated CCM and a previous CCM is larger than a threshold value.

In a further possible implementation form of the first aspect, the UE is configured to estimate the communication channel between the base station and the UE via the IRS based on the plurality of received pilot signals from the base station reflected by the IRS with the second plurality of reflection configurations.

In a further possible implementation form of the first aspect, the UE is configured to control the IRS to operate with the plurality of reflection configurations for reflecting the plurality of pilot signals from the base station to the UE based on a codebook. The codebook may define a mapping between a plurality of codes and the plurality of reflection configurations.

In a further possible implementation form of the first aspect, the UE is configured to receive, in response to a configuration information request, IRS configuration information from the IRS. The UE may be further configured to generate the codebook based on the IRS configuration information.

In a further possible implementation form of the first aspect, the UE is configured to control the IRS to operate with the plurality of reflection configurations for reflecting the plurality of pilot signals from the base station for a plurality of time slots. Each time slot may include one or more pilot slots for accommodating one or more of the plurality of pilot signals from the base station, and one or more data slots for accommodating one or more of a plurality of data signals from the base station.

In a further possible implementation form of the first aspect, each time slot includes one or more pilot slots for controlling the IRS to operate with one or more of the first plurality of reflection configurations and one or more pilot slots for controlling the IRS to operate with one or more of the second plurality of reflection configurations.

In a further possible implementation form of the first aspect, the one or more pilot slots of a first time slot of the plurality of time slots include one or more pilot slots for controlling the IRS to operate with a first subset of the first plurality of reflection configurations and/or the second plurality of reflection configurations and the one or more pilot slots of a second time slot of the plurality of time slots include one or more pilot slots for controlling the IRS to operate with a second subset of the first plurality of reflection configurations and/or the second plurality of reflection configurations. The first subset of the first plurality of reflection configurations and/or the second plurality of reflection configurations and the second subset of the first plurality of reflection configurations and/or the second plurality of reflection configurations may be different.

In a further possible implementation form of the first aspect, if the number of the one or more pilot slots of each time slot is smaller than or equal to the number of reflection configurations of the second plurality of reflection configurations, the UE is further configured to send a request to the base station for adjusting the number of pilot slots in each time slot.

In a further possible implementation form of the first aspect, the UE is configured to control the IRS to operate with the plurality of reflection configurations by adjusting a respective signal amplitude and/or a respective signal phase shift at each of a plurality of reflection elements of the IRS.

In a further possible implementation form of the first aspect, the UE is further configured to communicate with the base station based on the estimate of the communication channel between the base station and the UE via the IRS.

According to a second aspect, a method for operating a UE for communication with a base station over a communication channel via an IRS is provided. The method includes controlling the IRS to operate with a plurality of reflection configurations for reflecting a plurality of pilot signals sent from the base station to the UE for probing the channel between the base station, IRS, and the UE, where the plurality of reflection configurations of the IRS include a first plurality of reflection configurations for estimating by the UE a channel covariance matrix, CCM, of the communication channel between the base station and the UE via the IRS, and a second plurality of reflection configurations for estimating by the UE the communication channel between the base station and the UE via the IRS.

The method according to the second aspect of the embodiments can be performed by the UE according to the first aspect of the embodiments. Thus, further features of the method according to the second aspect of the embodiments result directly from the functionality of the UE according to the first aspect of the embodiments, as well as its different implementation forms described above and below.

According to a third aspect, an IRS for assisting communication over a communication channel between a base station and a UE is provided. The IRS includes a plurality of reflection elements adjustable in phase and/or amplitude for supporting a plurality of reflection configurations. The IRS is configured to operate with a plurality of reflection configurations for reflecting a plurality of pilot signals sent from the base station to the UE for probing the channel between the base station, IRS, and the UE. The plurality of reflection configurations of the IRS includes a first plurality of reflection configurations for estimating by the UE a channel covariance matrix, CCM, of the communication channel between the base station and the UE via the IRS, and a second plurality of reflection configurations for estimating by the UE the communication channel between the base station and the UE via the IRS.

In a further possible implementation form of the third aspect, the IRS is configured to operate with the plurality of reflection configurations for reflecting the plurality of pilot signals sent from the base station to the UE based on a codebook. The codebook may define a mapping between a plurality of codes and the plurality of reflection configurations.

In a further possible implementation form of the third aspect, the IRS is configured to transmit, in response to a configuration information request from the UE, IRS configuration information to the UE for generating the codebook based on the IRS configuration information.

In a further possible implementation form of the third aspect, the IRS is configured to operate with the plurality of reflection configurations for reflecting the plurality of pilot signals sent from the base station for a plurality of time slots. Each time slot may include one or more pilot slots for accommodating one or more of the plurality of pilot signals from the base station and one or more data slots for accommodating one or more of a plurality of data signals from the base station.

In a further possible implementation form of the third aspect, each time slot may include one or more pilot slots for the IRS to operate with one or more of the first plurality of reflection configurations and one or more pilot slots for the IRS to operate with one or more of the second plurality of reflection configurations.

In a further possible implementation form of the third aspect, the one or more pilot slots of a first time slot of the plurality of time slots include one or more pilot slots for the IRS to operate with a first subset of the first plurality of reflection configurations and/or the second plurality of reflection configurations and the one or more pilot slots of a second time slot of the plurality of time slots include one or more pilot slots for the IRS to operate with a second subset of the first plurality of reflection configurations and/or the second plurality of reflection configurations. The first subset and the second subset of the first plurality of reflection configurations and/or the second plurality of reflection configurations may be different.

According to a fourth aspect, a method for operating an IRS for assisting communication over a communication channel between a base station and a UE is provided. The IRS includes a plurality of reflection elements adjustable in phase and/or amplitude for supporting a plurality of reflection configurations. The method includes operating the IRS with a plurality of reflection configurations for reflecting a plurality of pilot signals sent from the base station to the UE for probing the channel between the base station, IRS, and the UE, where the plurality of reflection configurations of the IRS include a first plurality of reflection configurations for estimating by the UE a channel covariance matrix (CCM) of the communication channel between the base station and the UE via the IRS and a second plurality of reflection configurations for estimating by the UE the communication channel between the base station and the UE via the IRS.

The method according to the fourth aspect of the embodiments can be performed by the IRS according to the third aspect of the embodiments. Thus, further features of the method according to the fourth aspect of the embodiments result directly from the functionality of the IRS according to the third aspect of the embodiments as well as its different implementation forms described above and below.

According to a fifth aspect, a base station for communication with a UE over a communication channel via an IRS is provided. The base station is configured to transmit a plurality of pilot signals for reflection of the plurality of pilot signals by the IRS operating with a plurality of reflection configurations for a plurality of time slots. Each time slot includes one or more pilot slots for transmitting one or more of the plurality of pilot signals and one or more data slots for transmitting one or more of a plurality of data signals. In response to receiving a request from the UE, the base station is configured to adjust a number of the one or more pilot slots for each time slot.

In a further possible implementation form of the fifth aspect, the plurality of reflection configurations of the IRS includes a first plurality of reflection configurations for estimating by the UE a CCM of the communication channel between the base station and the UE via the IRS, and a second plurality of reflection configurations for estimating by the UE the communication channel between the base station and the UE via the IRS. The base station may be configured to receive information from the UE and/or the IRS about the first and/or the second plurality of reflection configurations of the IRS.

According to a sixth aspect, a method for operating a base station for communication with a UE over a communication channel via an IRS is provided. The method includes transmitting a plurality of pilot signals for reflection of the plurality of pilot signals by the IRS operating with a plurality of reflection configurations for a plurality of time slots, where each time slot includes one or more pilot slots for transmitting one or more of the plurality of pilot signals and one or more data slots for transmitting one or more of a plurality of data signals. The method further includes, in response to receiving a request from the UE, adjusting a number of the one or more pilot slots for each time slot.

The method according to the sixth aspect of the embodiments can be performed by the base station according to the fifth aspect of the embodiments. Thus, further features of the method according to the sixth aspect of the embodiments result directly from the functionality of the base station according to the fifth aspect of the embodiments as well as its different implementation forms described above and below.

According to a seventh aspect, a computer program product is provided, including a non-transitory computer-readable storage medium for storing a program code which causes a computer or a processor to perform the method according to the second aspect, the method according to the fourth aspect or the method according to the sixth aspect, when the program code is executed by the computer or the processor.

Details of one or more embodiments are set forth in the accompanying drawings and the description below. Other features, objects, and advantages will be apparent from the description and drawings.

### BRIEF DESCRIPTION OF THE DRAWINGS

In the following, embodiments are described in more detail with reference to the attached figures and drawings, in which:

FIG. 1 shows a schematic diagram illustrating a wireless network including a UE, an IRS, and a base station;

FIG. 2 is a schematic diagram illustrating a first plurality of reflection configurations at an IRS according to an embodiment;

FIG. 3 is a schematic diagram illustrating time slots implemented by embodiments herein;

FIG. 4a is a schematic diagram illustrating a probing based on a plurality of reflection configurations implemented by embodiments herein;

FIG. 4b is a schematic diagram illustrating a probing based on a plurality of reflection configurations implemented by embodiments herein;

FIG. 4a ic a schematic diagram illustrating a probing based on a plurality of reflection configurations implemented by embodiments herein;

FIG. 5 is a signaling diagram illustrating a communication session between a base station, an IRS, and a UE according to an embodiment;

FIG. 6 is a flow diagram illustrating a method for operating a UE for communication with a base station over a communication channel via an IRS according to an embodiment;

FIG. 7 is a flow diagram illustrating a method for operating an IRS acc for assisting communication over a communication channel between a base station and a UE according to an embodiment; and

FIG. 8 is a flow diagram illustrating a method for operating a base station for communication with a UE over a communication channel via an IRS according to an embodiment.

In the following, identical reference signs refer to identical or at least functionally equivalent features.

### DETAILED DESCRIPTION OF THE EMBODIMENTS

In the following description, reference is made to the accompanying figures which show, by way of illustration, specific aspects of embodiments or specific aspects in which embodiments may be used. It is understood that embodiments may be used in other aspects and include structural or logical changes not depicted in the figures. The following detailed description, therefore, is not to be taken in a limiting sense, and the scope of the embodiments is not limited to just the following description.

For instance, it is to be understood that an embodiment in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. Moreover, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

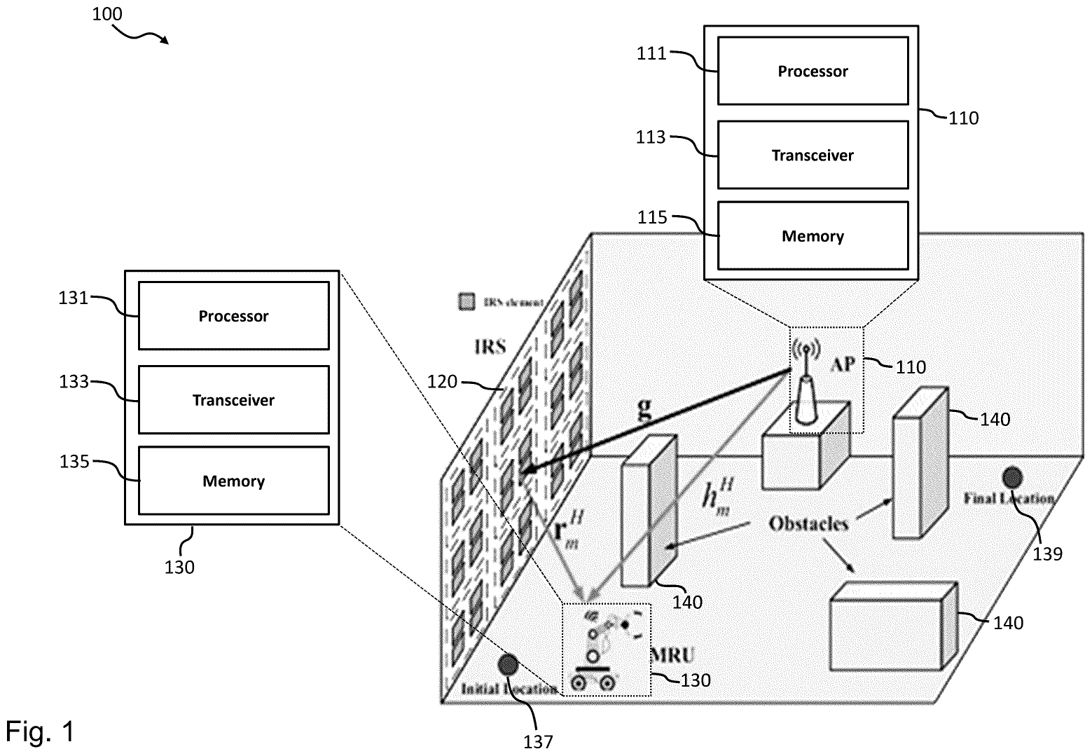

FIG. 1 shows a schematic diagram illustrating a wireless network 100 including a user equipment (UE) 130 according to an embodiment, an intelligent reflecting surface (IRS) 120 according to an embodiment, and a base station 110 according to an embodiment. FIG. 1 illustrates an exemplary scenario addressed by embodiments herein, such as the wireless network 100 with the IRS 120 installed, by way of example, on a wall of a factory hall. The wireless network 100 further includes the base station 110, which may be implemented as a gNB 110 and which in the exemplary embodiment shown in FIG. 1 is located at a, for example, fixed, location and which serve one of a plurality of, such as mobile, UE 130. The IRS 120 may be a planar array having a large number, in particular more than 100 or more than 1000, of (nearly) passive reflecting elements with reconfigurable parameters. Each of these elements can for example be configured to reflect an impinging radio wave with an individually configurable phase shift and/or amplitude, which results in the formation of a reflection beam (beam), whose direction can be actively controlled by choosing the phase shifts for the reflecting elements of the IRS 120 accordingly. In an embodiment, the IRS 120 is controlled by the UE 130. As illustrated in FIG. 1, if sufficient elements of the IRS 120 are available, the environment, i.e., the factory hall in the example shown in FIG. 1, can be configured such that LOS-like channel conditions can be established for any UE 130 in the factory hall (despite obstacles, such as machines 140), created by a direct link from the base station 110 via the associated IRS 120 forming a reflection beam directed towards this UE 130.

As illustrated in FIG. 1, the UE 130 may include a processing circuitry 131 and a transceiver 133. The processing circuitry 131 may be implemented in hardware and/or software. The hardware may include digital circuitry, or both analog and digital circuitry. Digital circuitry may include components such as application-specific integrated circuits (ASICs), field-programmable arrays (FPGAs), digital signal processors (DSPs), or one or more general-purpose processors. Moreover, the UE 130 may include a memory 135 configured to store executable program code which, when executed by the processing circuitry 131, causes the UE 130 to perform the functions and operations described herein.

Likewise, the base station 110 may include a processing circuitry 111 and a transceiver 113. The processing circuitry 111 may be implemented in hardware and/or software. The hardware may include digital circuitry, or both analog and digital circuitry. Digital circuitry may include components such as application-specific integrated circuits (ASICs), field-programmable arrays (FPGAs), digital signal processors (DSPs), or one or more general-purpose processors. Moreover, the base station 110 may include a memory 115 configured to store executable program code which, when executed by the processing circuitry 111, causes the base station 110 to perform the functions and operations described herein.

The UE 130 may be in movement while receiving the reflection beam, for example on a path from an initial location 137 to a final location 139. The path, the initial location 137 and/or the final location 139 may be determined by the processing circuitry 131 of the UE 130 prior to the movement of the UE 130 and/or may be stored in the memory 135 of the UE 130.

Similar to standard multiple-input-multiple-output (MIMO) systems, accurate channel knowledge of the links of the IRS 120 can be necessary to reap the benefits of the IRS 120. A scheme for channel estimation may include sending pilot signals that are known to both the gNB and the UE 130 from the gNB to the UE 130. Given the received signal and the knowledge of its pilots, the UE 130 can estimate the required channels. In the context of a movement of the UE 130, which may for example be a moving robot 130, channel estimation is particularly challenging due to the robot mobility. High mobility reduces the size of the channel coherence block, i.e., the number of time and frequency slots where the channel is (approximately) constant. It is well known that in this case a larger portion of the available resources would need to be spent on training (i.e., the number of pilot signals needed for channel estimation), reducing the effective data throughput. The large number of elements of the IRS 120 is an additional challenge regardless of mobility conditions: If straight-forward estimation methods such as least squares (LS) methods are employed, the required training overhead scales with the number of elements, i.e., antennas of the IRS 120, and becomes therefore undesirably large. This further reduces the effective data throughput.

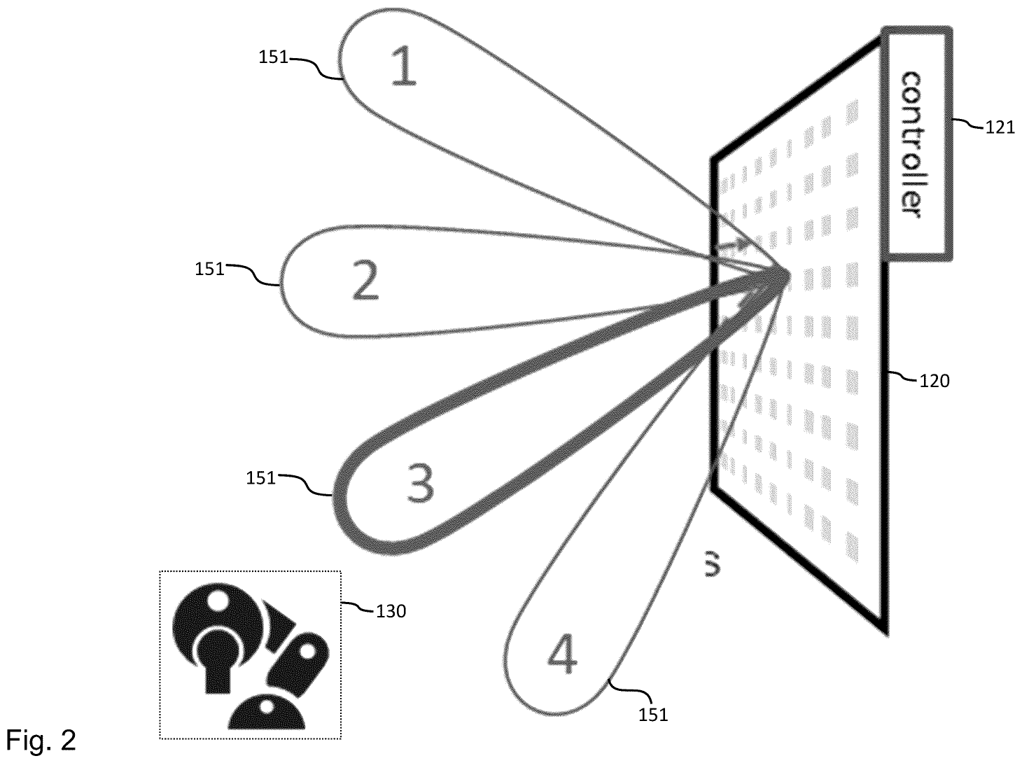

According to an embodiment which is described further below with reference to the FIGS. 2, 3 and 4a-c, the user equipment, UE 130 is configured for communication with the base station 110 over a communication channel, such as the wireless network 100, via the IRS 120.

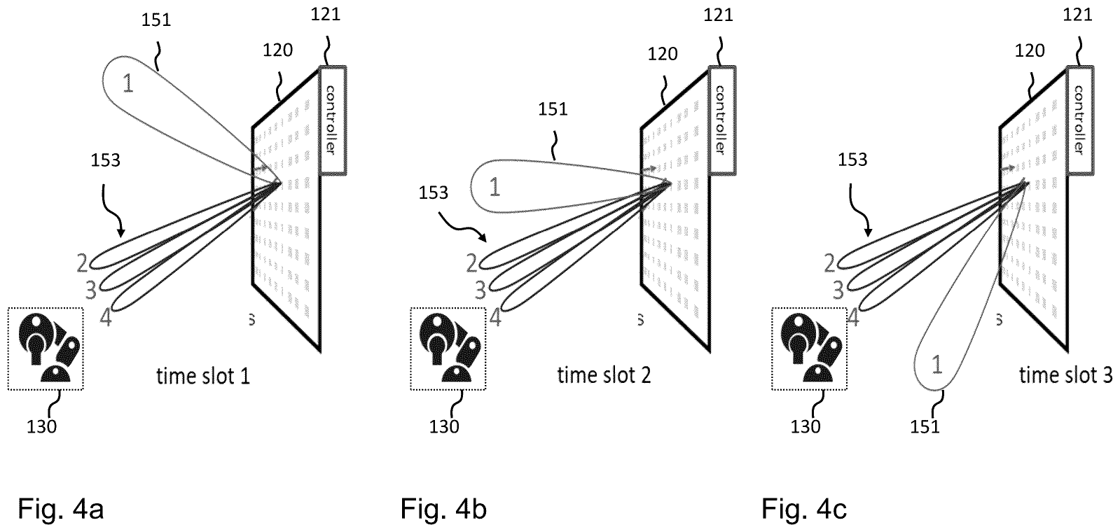

The UE 130 is configured to control the IRS 120 to operate with a plurality of reflection configurations 151, 153 (illustrated in FIGS. 4a-c) for reflecting a plurality of pilot signals from the base station 110 to the UE 130 for probing the channel between the base station 110, IRS 120, and the UE 130.

The plurality of reflection configurations 151, 153 of the IRS 120 includes a first plurality of reflection configurations 151 (according to FIG. 2) for estimating by the UE 130 a channel covariance matrix (CCM) of the communication channel between the base station 110 and the UE 130 via the IRS 120, and a second plurality of reflection configurations 153 (according to FIGS. 4a-c) for estimating by the UE 130 the communication channel between the base station 110 and the UE 130 via the IRS 120. FIGS. 4a-c illustrate the exemplary plurality of reflection configurations used by the IRS 120 at three different time slots, including a changing first reflection configuration 151 (referred to as beam 1 in FIGS. 4a-c) and a constant second plurality of reflection configurations 153 (referred to as beams 2, 3 and 4 in FIGS. 4a-c).

The UE 130 may be configured to determine the CCM based on the plurality of received pilot signals from the base station 110 reflected by the IRS 120 with the first plurality of reflection configurations 151. The UE 130 may be configured to determine the second plurality of reflection configurations 153 based on the CCM. For example, the UE 130 may be configured to determine the second plurality of reflection configurations 153 based on a plurality of eigenvectors of the CCM, for example based on a plurality of eigenvectors of the CCM having the largest eigenvalues.

The UE 130 may be configured to update the CCM based on the plurality of received pilot signals from the base station 110 reflected by the IRS 120 with the first plurality of reflection configurations 151. The UE 130 may be configured to update the second plurality of reflection configurations 153 based on an updated CCM, if a value of a difference measure between the updated CCM and a previous CCM is larger than a threshold value.

Complementary to the UE 130, the IRS 120, is configured for assisting the communication over the communication channel between the base station 110 and the UE 130. The IRS 120 includes the plurality of reflection elements which are adjustable in phase and/or amplitude for supporting the plurality of reflection configurations 151, 153. The IRS 120 is configured to operate with the plurality of reflection configurations 151, 153 for reflecting the plurality of pilot signals sent from the base station 110 to the UE 130 for probing the channel between the base station, IRS 120 and the UE 130.

The UE 130 may be further configured to control the IRS 120 to operate with the plurality of reflection configurations 151, 153 by adjusting a respective signal amplitude and/or a respective signal phase shift at each of the plurality of reflection elements of the IRS 120.

The UE 130 may be configured to control the IRS 120 to operate with the plurality of reflection configurations 151, 153 for reflecting the plurality of pilot signals sent from the base station 110 to the UE 130 based on a codebook. The codebook may define a mapping between a plurality of codes and the plurality of reflection configurations 151, 153. Further, the IRS 120 may be configured to operate with the plurality of reflection configurations 151, 153 for reflecting the plurality of pilot signals sent from the base station 110 to the UE 130 based on the codebook.

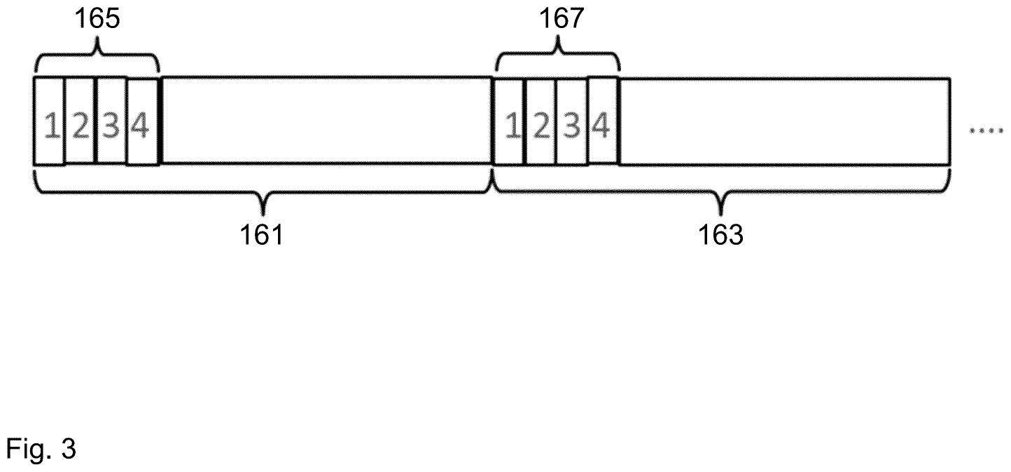

The base station 110 is configured for communication with the UE 130 over the communication channel via the IRS 120. As further illustrated in FIG. 3, the base station 110 is configured to transmit the plurality of pilot signals for reflection of the plurality of pilot signals by the IRS 120 operating with the plurality of reflection configurations 151, 153 for a plurality of time slots 161, 163. Each time slot 161, 163 includes one or more pilot slots 165, 167 for transmitting one or more of the plurality of pilot signals and one or more data slots (which are also schematically indicated in FIG. 3 as the white space between the pilot slots 165, 167 and the end of the time slots 162, 163, respectively) for transmitting one or more of a plurality of data signals. The base station 110 is further configured to, in response to receiving a request from the UE 130, adjust a number of the one or more pilot slots 165, 167 for each time slot 161, 163. The base station 110 may be configured to receive information from the UE 130 and/or the IRS 120 about the first and/or the second plurality of reflection configurations 153 used by the IRS 120, so that the base station 110 knows the specific configuration used by the IRS 120 during each time slot.

The UE 130 may be configured to estimate the communication channel between the base station 110 and the UE 130 via the IRS 120 based on the plurality of received pilot signals from the base station 110 reflected by the IRS 120 with the second plurality of reflection configurations 153.

The UE 130 may be further configured to communicate with the base station 110 based on the estimate of the communication channel between the base station 110 and the UE 130 via the IRS 120.

The UE 130 may be configured to control the IRS 120 to operate with the plurality of reflection configurations 151, 153 for reflecting the plurality of pilot signals sent from the base station 110 for the plurality of time slots 161, 163. Correspondingly, the IRS 120 may be configured to operate with the plurality of reflection configurations 151, 153 for reflecting the plurality of pilot signals sent from the base station 110 for the plurality of time slots 161, 163.

As illustrated in FIG. 3, each time slot 161, 163 may include one or more pilot slots 165, 167 for accommodating one or more of the plurality of pilot signals from the base station 110 and one or more data slots for accommodating one or more of a plurality of data signals from the base station 110.

Each time slot 161, 163 may includes one or more pilot slots 165, 167 for controlling the IRS 120 to operate with one or more of the first plurality of reflection configurations 151 and one or more pilot slots 165, 167 for controlling the IRS 120 to operate with one or more of the second plurality of reflection configurations 153.

The one or more pilot slots 165 of a first time slot 161 of the plurality of time slots 161, 163 may include one or more pilot slots 165 for controlling the IRS 120 to operate with a first subset of the first plurality of reflection configurations 151 and/or the second plurality of reflection configurations 153 and the one or more pilot slots 167 of a second time slot 163 of the plurality of time slots 161, 163 may include one or more pilot slots 167 for controlling the IRS 120 to operate with a second subset of the first plurality of reflection configurations 151 and/or the second plurality of reflection configurations 153. The first subset of the first plurality of reflection configurations 151 and/or the second plurality of reflection configurations 153 and the second subset of the first plurality of reflection configurations 151 and/or the second plurality of reflection configurations 153 may be different. As already mentioned above, FIGS. 4a-c illustrate the exemplary plurality of reflection configurations used by the IRS 120 at three different time slots, including a changing first reflection configuration 151 (referred to as beam 1 in FIGS. 4a-c) and a constant second plurality of reflection configurations 153 (referred to as beams 2, 3 and 4 in FIGS. 4a-c).

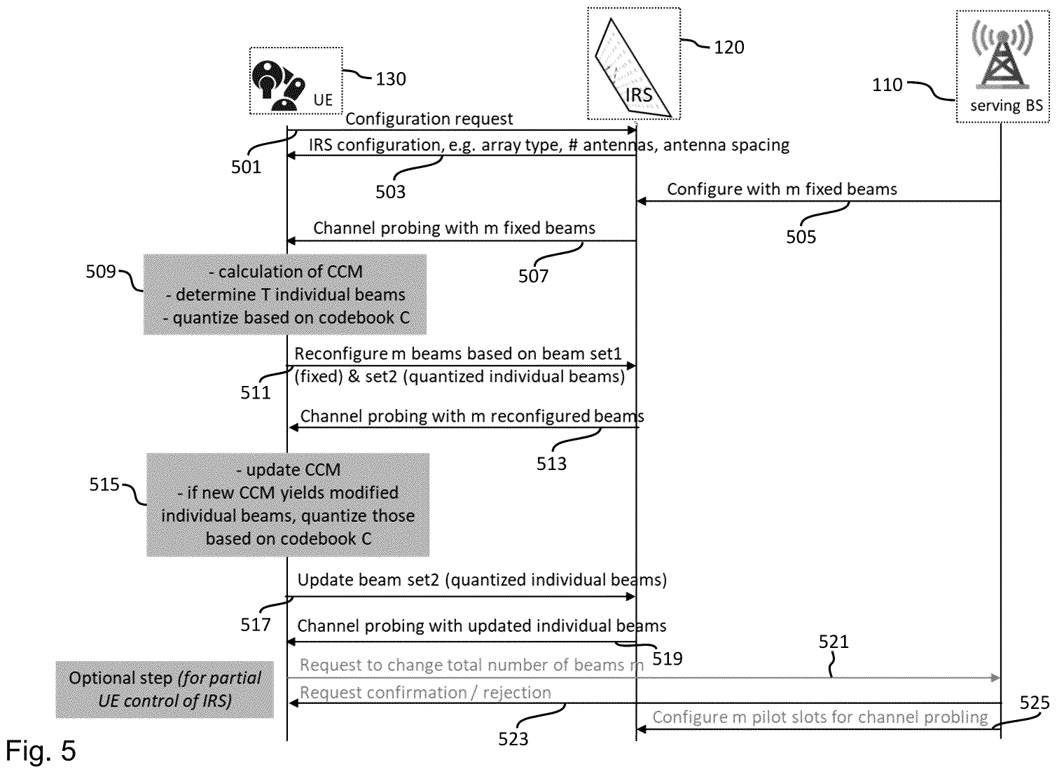

As will be described in more detail under FIG. 5 below, if the number of the one or more pilot slots 165, 167 of each time slot 161, 163 is smaller than or equal to the number of reflection configurations of the second plurality of reflection configurations 153, the UE 130 may be further configured to send a request to the base station 110 for adjusting the number of pilot slots 165, 167 in each time slot 161, 163.

As will be further described in more detail under FIG. 5 below, the IRS 120 may be configured to transmit, in response to a configuration information request from the UE 130, IRS configuration information to the UE 130 for generating the codebook based on the IRS configuration information. Further, the UE 130 may be configured to receive, in response to the configuration information request, IRS configuration information from the IRS 120. The UE 130 may be further configured to generate the codebook based on the IRS configuration information.

The UE 130 may thus allow the configuration of each antenna element of the IRS 120 with a different phase and/or amplitude configuration, resulting in a much more flexible design compared to a set of fixed reflections beams. By adjusting the second plurality of reflection configurations 153, i.e., beams of the IRS 120 during channel estimation, a minimized channel estimation (MSE) may be achieved, based on exploiting CCM information as side information and knowledge about the minimum mean square error (MMSE) estimation procedure used by the UE 130. The MMSE estimation procedure may be in particular linear.

As already described above, the CCM may be estimated at the UE 130 based on the pilots transmitted by the base station 110 via the IRS 120, such as in the downlink. The second plurality of reflection configurations 153, i.e., the beams for adjustment, may be calculated directly at the UE 130 and are then may be directly signaled form the UE 130 to the IRS 120. Hence, the UE 130 may control the IRS 120, where the UE 130 may fully control the IRS 120 with authorization by the base station 110 of the wireless network 100.

FIG. 2 is a schematic diagram illustrating the first plurality of reflection configurations 151 at the IRS 120 according to an embodiment, and FIG. 3 is a schematic diagram illustrating the time slots 161, 163. As illustrated in FIG. 2, the IRS 120 may include a controller 121. The controller 121 of the IRS 120 may be configured to communicate with the UE 130 and/or the base station 110, such as by a communication interface of the IRS 120.

The first plurality of reflection configurations 151 may be used with the pilot slots 165, 167, i.e., a set of training pilots m<<N, where N is the number of IRS elements. As illustrated in FIG. 3, the m=4 pilot slots 165, 167 may be sent in each time slot 161, 163. During this channel probing phase, the IRS 120 may switch between the beams of the first plurality of reflection configurations 151 per each pilot slot, i.e., m fixed beams will be probed in the m=4 pilot slots 165, 167, allowing to estimate the instantaneous channels between base station, IRS, and UE and calculating the CCM from these estimated channels over several coherence blocks.

As described above, the two different sets of beams for dynamic configuration of the IRS 120 during channel probing with m pilots can be used. The first plurality of reflection configurations 151, i.e., the first set, includes the fixed beams, for example as originally configured, which are needed to estimate the CCM. The second plurality of reflection configurations 153, i.e., the second set, includes T individual beams derived from the CCM for accurate estimation of the instantaneous channels between base station, IRS, and UE.

Since the CCM may vary slowly over time, i.e., over the time slots 161, 163, there may be no need to estimate the first plurality of reflection configurations 151, i.e., the fixed beams, in every time slot 161, 163, and hence those beams may be distributed over successive time slots 161, 163 or they may be transmitted at fixed time intervals only, e.g., every nth time slot 161, 163.

FIGS. 4a-c are schematic diagrams illustrating a probing based on the plurality of reflection configurations 151, 153. As illustrated in FIGS. 4a-c, one beam of the first plurality of reflection configurations 151 may be probed per time slot 161, 163. On the other hand, estimates of the instantaneous channels between base station, IRS, and UE are needed at high accuracy, and hence the second plurality of reflection configurations 153, i.e., the individual beams, may be needed to be estimated more frequently. Consequently, the same individual beams may be probed every time slot, for example if T<m, as shown in the FIGS. 4a-c, where the same 3 individual beams of the second plurality of reflection configurations 153 are probed in each time slot 161, 163. For larger sets of individual beams of the second plurality of reflection configurations 153, for example for T>m, and slowly varying channels, the individual beams of the second plurality of reflection configurations 153 may be distributed over multiple successive time slots 161, 163, similarly as illustrated for the estimation of the fixed beams of the first plurality of reflection configurations 151.

As already described above, the UE 130 may be configured to control the IRS 120 to operate with the plurality of reflection configurations 151, 153 for reflecting the plurality of pilot signals from the base station 110 to the UE 130 based on the codebook. The codebook may include IRS beamforming vectors which may be used to quantize the individual IRS beams. The codebook may be known to both the UE 130 and the IRS 120.

A first procedure of a process based on the codebook may include one or more of the following steps.

In a first step of the first procedure, an initial setup may be performed. The IRS 120 may be configured with m fixed beams of the first plurality of reflection configurations 151 for channel estimation based on m pilots. This configuration may for example be done in a conventional way by the base station 110.

In a second step of the first procedure, the UE 130 may estimate the CCM based on channel measurements over several successive time slots 161, 163.

In a third step of the first procedure, the UE 130 may determine T individual beams of the second plurality of reflection configurations 153 from the CCM for accurate estimation of the instantaneous channels between base station, IRS, and UE.

In a fourth step of the first procedure, the UE 130 may use the codebook for quantizing the T individual beams of the second plurality of reflection configurations 153 and signals these codewords to the controller 121 of the IRS 120.

In a fifth step of the first procedure, the controller 121 of the IRS 120 may build the two beam sets for channel probing, which represent subsets of the first plurality of reflection configurations 151 and the second plurality of reflections configurations 153, respectively. In case of T<m, the first beam set (i.e., subset of the first plurality of reflection configurations 151) may include (m−T) beams, which may be configured by using (m−T) of the m fixed beams per each time slot 161, 163. This results in [m/(m−T)] time slots 161, 163 needed for probing all the m fixed beams of the first plurality of reflection configurations 151 with size m. The second beam set (i.e., subset of the second plurality of reflection configurations 153) may include the T individual beams signaled by the UE 130.

In a sixth step of the first procedure, the controller 121 of the IRS 120 may configure the IRS 120 with the beam sets of the first and second plurality of reflection configurations 151, 153 per each time slot 161, 163 for channel probing.

In a seventh step of the first procedure, the UE may use the first plurality of reflection configurations 151 for estimating and updating the CCM, and the second plurality of reflection configurations 153 for accurate estimation of the instantaneous channel between base station, IRS, and UE.

In an eighth step of the first procedure, if the updated CCM differs significantly from CCM used to derive the T individual beams of the second plurality of reflection configurations 153, which may for example occur due to movement of the UE 130, the T individual beams of the second plurality of reflection configurations 153 may be updated and signaled to the controller 121 of the IRS 120. Following step 8, the process may jump back to the third step of the first procedure.

Thus, the base station 110, the IRS 120 and the UE 130 are configured for configuration of IRS beams by the UE 130, for example the robot 130, for channel probing based on at least two beam sets, i.e., the plurality of reflection configurations 151, 153. The first plurality of reflection configurations 151 may use fixed beams for CCM estimation, while the second plurality of reflection configurations 153 may use individual beams, i.e., specific for the IRS-UE link, for accurate estimation of the instantaneous channels between base station, IRS, and UE. The beams of the second plurality of reflection configurations 153 may be derived from the CCM and may be changed dynamically according to, e.g., mobility conditions. To allow for an efficient IRS configuration, the UE 130 and IRS 120 may use the predetermined codebooks to quantize the individual beams, i.e., the UE 130 may for example select suitable beams from the codebook and signal their indices to the IRS 120. The procedure may be repeated whenever the CCM changes.

The procedure and the embodiments described herein are advantageous at least for robotic features. Unlike a standard UE 130, the robot may be directly aware of his movements/mobility (as illustrated by the initial location 137 and the final location 139 in FIG. 1) and can use this information to optimize the signaling directly and predict when an update of the individual beams based on the CCM becomes necessary. Additionally, the robot can request the base station 110 to change the number of pilots used for CCM estimation based on its mobility conditions. As will be appreciated, the procedure and the embodiments described herein above and below still apply to a standard UE 130 who could apply the method whenever the CCM changes.

The procedure described above relates for the case that the number of individual beams T is smaller than the available pilot slots m in each time slot (T<m). According to embodiments described below, the procedure can be performed for cases where T≥m. For those cases, k is assumed to be the smallest integer satisfying T<km, i.e., k specifies the number of time slots 161, 163 needed for probing the entire set of T individual beams of the second plurality of reflection configurations 153.

In case of km>T>m, a second procedure may include one or more of the first to fourth step of the first procedure. The second procedure may further include one or more of the following steps:

In a fifth step of the second procedure, after receiving the codewords, the controller 121 of the IRS 120 may build the two beam sets for channel probing. The first plurality of reflection configurations 151 may include (km−T) beams, which may be configured by taking (km−T) of the m fixed beams every k^{th} time slot 161, 163. This results in k┌km/(km−T)┐ time slots needed for probing all the beams of the first plurality of reflection configurations 151, i.e., the original set of fixed beams with size m. The second plurality of reflection configurations 153 may include m beams, being configured by taking m of the T individual beams per each time slot 1≠k, and (T mod m) beams of the T individual beams in each k^{th} time slot 161, 163.

In a sixth step of the second procedure, the controller 121 of the IRS 120 may configure the IRS 120 with the beam sets of the first and second plurality of reflection configurations 151, 153 per each time slot 161, 163 for channel probing.

A seventh step of the second procedure may correspond to the seventh step of the first procedure.

An eighth step of the second procedure may correspond to the eighth step of the first procedure.

In case of km=T, a third procedure may include one or more of the first to fourth step of the first procedure. The third procedure may further include one or more of the following steps:
In a fifth step of the third procedure, after receiving the codewords, the controller 121 of the IRS 120 may build the two beam sets of the first and second plurality of reflection configurations 151, 153 for channel probing. The first plurality of reflection configurations 151 may include m fixed beams, which may be configured for transmission every n^{th} time slot (n>k+1), and the second plurality of reflection configurations 153 may include m beams, which may be configured by taking m of the T individual beams per each time slot 1≠n.
In a sixth step of the third procedure, the controller 121 of the IRS 120 may configure the IRS 120 with the beam sets of the first and second plurality of reflection configurations 151, 153 per each time slot 161, 163 for channel probing.
A seventh step of the third procedure may correspond to the seventh step of first procedure or to the seventh step of the second procedure.
An eighth step of the third procedure may correspond to the eighth step of first procedure or to the eighth step of second procedure.

FIG. 5 is a signaling diagram illustrating a communication session between the base station 110 according to an embodiment, the IRS 120 according to an embodiment and the UE 130 according to an embodiment. Via the signaling illustrated in FIG. 5, the first, second and/or third procedure as well as the further embodiments described above and below can be realized. Prior to the communication session, the base station 110, the IRS 120 and the UE 130 may have been synchronized to enable beam switching synchronized with a symbol clock, for example based on one or more communication protocols of the wireless network 100.

In step 501 of FIG. 5, for an intention of controlling and configuring the IRS 120, the UE 130 may first send a configuration request to the controller 121 of the IRS 120.

In step 503 of FIG. 5, the IRS 120 may respond with its IRS configuration, which may include information about array type, number of antennas, antenna spacing, etc. Based on the IRS configuration received, the UE 130 may directly determine the codebook, which may be used later for quantizing the individual beams.

In step 505 of FIG. 5, the base station 110 may configure the IRS 120 with m fixed beams of the first plurality of reflection configurations 151 for channel probing. The base station 110 may further configure the pilot slots 165, 167 per each time slot 161, 163 accordingly.

In step 507 of FIG. 5, during channel probing, in which the base station 110 sends its pilots in the m pilot slots 165, 167 per time slot 161, 163, the IRS 120 may switch between the m fixed beams. The UE 130 may carry out the channel estimation.

In step 509 of FIG. 5, after the channel has been estimated, potentially over several channel coherence blocks, the UE 130 may determine the CCM and may derive from the CCM the T individual beams of the second plurality of reflection configurations 153, which are quantized based on the codebook.

In step 511 of FIG. 5, the UE 130 may signal the individual beams of the second plurality of reflection configurations 153 to the IRS 120 to enable reconfiguration of the m beams used for channel probing based on the first plurality of reflection configurations 151 including the fixed beams and the second plurality of reflection configurations 153 including the individual beams.

In step 513 of FIG. 5, the next channel probing phase may be carried out with the reconfigured beams, i.e., the IRS 120 may now switch between the m reconfigured beams while the base station 110 transmits its pilot slots 165, 167.

In step 515 of FIG. 5, the UE 130 may update the CCM based on the measurements obtained for the fixed beams of the first plurality of reflection configurations 151 over several channel coherence blocks. Once the CCM has substantially changed, it may yield new individual beams, which are then calculated and quantized based on the codebook by the UE 130.

In step 517 of FIG. 5, the UE 130 may signal the updated individual beams to the IRS 120 to enable update of the second plurality of reflection configurations 153.

In step 519 of FIG. 5, the next channel probing phase may be carried out with the updated individual beams in the second plurality of reflection configurations 153.

As further illustrated in FIG. 5, if the UE 130 may have only partial control of the IRS 120, i.e., if the base station 110 may keep some level of control over the IRS 120, the following optional steps may be performed.

In optional step 521 of FIG. 5, the UE 130 may require the base station 110 to transmit more pilots per time slot 161, 163, e.g. in case of high mobility (for example a fast movement along the path described above under FIG. 1) yielding short channel coherence intervals. Then the UE 130 may request the base station 110 to change the number of pilot slots m transmitted per time slot 161, 163. This may also imply an increase in the number m of fixed beams in the original set, i.e., the first plurality of reflection configurations 151.

In optional step 523 of FIG. 5, the base station 110 may confirm or reject the request.

In optional step 525 of FIG. 5, in case of confirmation, the base station 110 may configure the pilot slots 165, 167 according to the new number m and may inform and/or configure the controller 121 of the IRS 120 accordingly. The new configuration may then be applied in the next channel probing phase.

Advantageously, the embodiments herein can result in significant performance improvements compared to conventional methods with small additional signaling from the robot/UE 130 to the IRS 120. The performance gains can be obtained due to the added degrees of freedom to configure each IRS antenna element with a different phase shift and/or amplitude and thus to form arbitrary beams, allowing for a much more flexible design compared to conventional methods. The performance gains can be further obtained due to the use of an optimal IRS phase shift configuration (in form of the individual beams of the second plurality of reflection configurations 153) during channel estimation that can explicitly minimize the MSE based on CCM information for the individual IRS-UE link, unlike conventional methods which for example use a fixed configuration, for example independent of the CCM.

The embodiments herein allow the use of arbitrary IRS beamforming codebooks, e.g., Hadamard codebooks and not necessarily DFT codebooks for beam quantization.

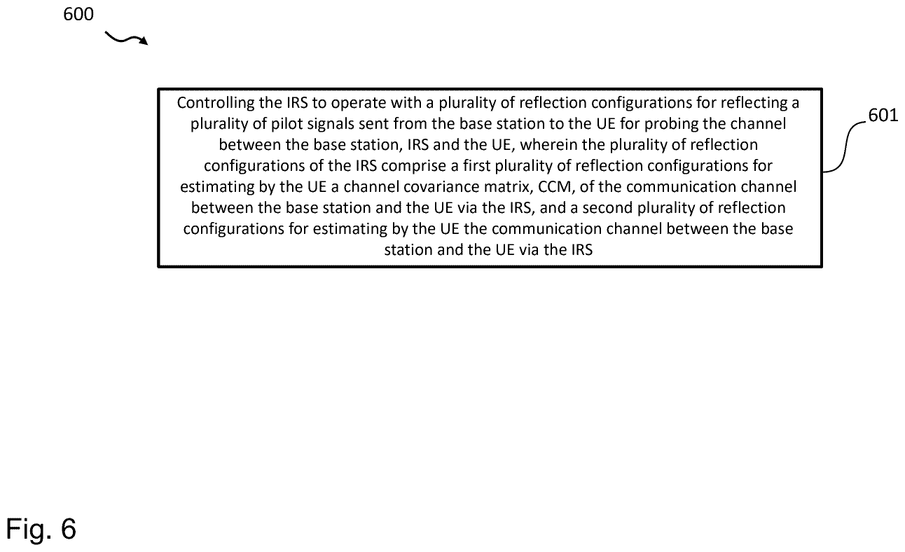

FIG. 6 is a flow diagram illustrating a method 600 for operating the UE 130 according to an embodiment for communication with the base station 110 according to an embodiment over a communication channel via the IRS 120 according to an embodiment.

The method 600 includes controlling 601 the IRS 120 to operate with the plurality of reflection configurations 151, 153 for reflecting a plurality of pilot signals sent from the base station 110 to the UE 130 for probing the channel between the base station, IRS 120 and the UE 130, where the plurality of reflection configurations 151, 153 of the IRS 120 include the first plurality of reflection configurations 151 for estimating by the UE 130 a channel covariance matrix, CCM, of the communication channel between the base station 110 and the UE 130 via the IRS 120, and the second plurality of reflection configurations 153 for estimating by the UE 130 the communication channel between the base station 110 and the UE 130 via the IRS 120.

The method 600 can be performed by the UE 130 according to an embodiment. Thus, further features of the method 600 result directly from the functionality of the UE 130 as well as the different embodiments thereof described above and below.

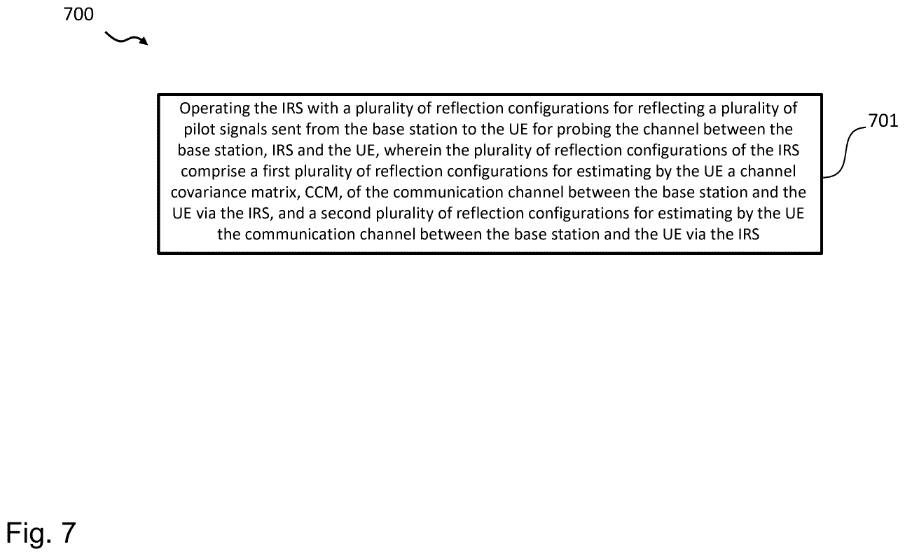

FIG. 7 is a flow diagram illustrating a method 700 for operating the IRS 120 according to an embodiment for assisting communication over a communication channel between the base station 110 according to an embodiment and the UE 130 according to an embodiment. As already described above, the IRS 120 includes a plurality of reflection elements adjustable in phase and/or amplitude for supporting the plurality of reflection configurations 151, 153.

The method 700 includes operating 701 the IRS 120 with the plurality of reflection configurations 151, 153 for reflecting a plurality of pilot signals sent from the base station 110 to the UE 130 for probing the channel between the base station, IRS 120 and the UE 130, where the plurality of reflection configurations 151, 153 of the IRS 120 include the first plurality of reflection configurations 151 for estimating by the UE 130 a channel covariance matrix, CCM, of the communication channel between the base station 110 and the UE 130 via the IRS 120, and the second plurality of reflection configurations 153 for estimating by the UE 130 the communication channel between the base station 110 and the UE 130 via the IRS 120.

The method 700 can be performed by the IRS 120 according to an embodiment. Thus, further features of the method 700 result directly from the functionality of the IRS 120 as well as the different embodiments thereof described above and below.

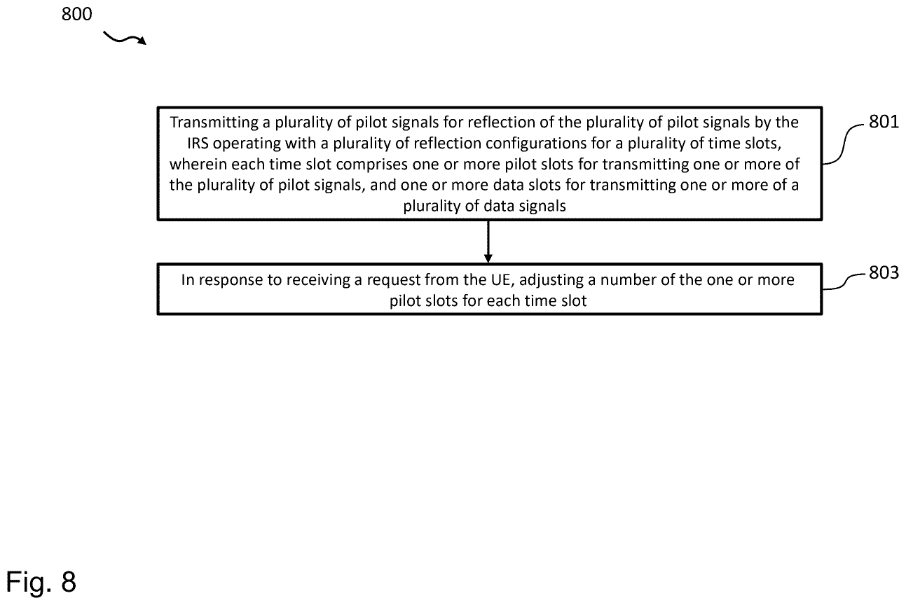

FIG. 8 is a flow diagram illustrating a method 800 for operating the base station 110 according to an embodiment for communication with the UE 130 according to an embodiment over a communication channel via the IRS 120 according to an embodiment.

The method 800 includes transmitting 801 a plurality of pilot signals for reflection of the plurality of pilot signals by the IRS 120 operating with the plurality of reflection configurations 151, 153 for the plurality of time slots 161, 163, where each time slot 161, 163 includes one or more pilot slots 165, 167 for transmitting one or more of the plurality of pilot signals and one or more data slots for transmitting one or more of a plurality of data signals.

The method 800 further includes, in response to receiving a request from the UE 130, adjusting 803 a number of the one or more pilot slots 165, 167 for each time slot 161, 163.

The method 800 can be performed by the base station 110 according to an embodiment. Thus, further features of the method 800 result directly from the functionality of the base station 110 as well as the different embodiments thereof described above and below.

A person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

In the several embodiments provided, it should be understood that the system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units may be integrated into one unit. Further, it should be appreciated that all descriptions of embodiments are non-limiting and that modification and variations are included in the scope of the embodiments.

1. A user equipment UE for communication with a base station over a communication channel via an intelligent reflective surface IRS, wherein the UE is configured to:
control the IRS to operate with a plurality of reflection configurations for reflecting a plurality of pilot signals sent from the base station to the UE for probing the channel between the base station, IRS, and the UE;
wherein the plurality of reflection configurations of the IRS comprises a first plurality of reflection configurations for estimating by the UE a channel covariance matrix CCM of the communication channel between the base station and the UE via the IRS, and a second plurality of reflection configurations for estimating, by the UE, the communication channel between the base station and the UE via the IRS.

2. The UE of claim 1, wherein the UE is further configured to determine the CCM based on the plurality of received pilot signals from the base station reflected by the IRS with the first plurality of reflection configurations.

3. The UE of claim 1, wherein the UE is further configured to determine the second plurality of reflection configurations based on the CCM.

4. The UE of claim 3, wherein the UE is further configured to determine the second plurality of reflection configurations based on a plurality of eigenvectors of the CCM.

5. The UE of claim 4, wherein the UE is further configured to determine the second plurality of reflection configurations based on a plurality of eigenvectors of the CCM having the largest eigenvalues.

6. The UE of claim 2, wherein the UE is further configured to update the CCM based on the plurality of received pilot signals from the base station reflected by the IRS with the first plurality of reflection configurations, wherein the UE is configured to update the second plurality of reflection configurations based on an updated CCM, when a value of a difference measure between the updated CCM and a previous CCM is larger than a threshold value.

7. The UE of claim 1, wherein the UE is further configured to estimate the communication channel between the base station and the UE via the IRS based on the plurality of received pilot signals from the base station reflected by the IRS with the second plurality of reflection configurations.

8. The UE of claim 1, wherein the UE is further configured to control the IRS to operate with the plurality of reflection configurations for reflecting the plurality of pilot signals sent from the base station to the UE based on a codebook, wherein the codebook defines a mapping between a plurality of codes and the plurality of reflection configurations.

9. The UE of claim 8, wherein the UE is further configured to receive, in response to a configuration information request, IRS configuration information from the IRS and wherein the UE is further configured to generate the codebook based on the IRS configuration information.

10. The UE of claim 1, wherein the UE is further configured to control the IRS to operate with the plurality of reflection configurations for reflecting the plurality of pilot signals sent from the base station for a plurality of time slots , wherein each time slot comprises one or more pilot slots for accommodating one or more of the plurality of pilot signals from the base station, and one or more data slots for accommodating one or more of a plurality of data signals from the base station.

11. The UE of claim 10, wherein each time slot comprises one or more pilot slots for controlling the IRS to operate with one or more of the first plurality of reflection configurations and one or more pilot slots for controlling the IRS to operate with one or more of the second plurality of reflection configurations.

12. The UE of claim 10, wherein the one or more pilot slots of a first time slot of the plurality of time slots comprise one or more pilot slots for controlling the IRS to operate with a first subset of the first plurality of reflection configurations and/or the second plurality of reflection configurations and wherein the one or more pilot slots of a second time slot of the plurality of time slots comprise one or more pilot slots for controlling the IRS to operate with a second subset of the first plurality of reflection configurations and/or the second plurality of reflection configurations, wherein the first subset of the first plurality of reflection configurations and/or the second plurality of reflection configurations and the second subset of the first plurality of reflection configurations and/or the second plurality of reflection configurations are different.

13. The UE of claim 10, wherein, if when the number of the one or more pilot slots of each time slot is smaller than or equal to the number of reflection configurations of the second plurality of reflection configurations, the UE is further configured to send a request to the base station for adjusting the number of pilot slots in each time slot.

14. The UE of claim 1 wherein the UE is further configured to control the IRS to operate with the plurality of reflection configurations by adjusting a respective signal amplitude and/or a respective signal phase shift at each of a plurality of reflection elements of the IRS.

15. The UE of claim 1, wherein the UE is further configured to communicate with the base station based on the estimate of the communication channel between the base station and the UE via the IRS.

16. A method for operating a user equipment UE for communication with a base station over a communication channel via an intelligent reflective surface IRS, the method comprising:
controlling the IRS to operate with a plurality of reflection configurations for reflecting a plurality of pilot signals sent from the base station to the UE for probing the channel between the base station, IRS, and the UE, wherein the plurality of reflection configurations of the IRS comprise a first plurality of reflection configurations for estimating by the UE a channel covariance matrix CCM of the communication channel between the base station and the UE via the IRS, and a second plurality of reflection configurations for estimating by the UE the communication channel between the base station and the UE via the IRS.

17. An intelligent reflecting surface IRS, for assisting communication over a communication channel between a base station and a user equipment UE, the IRS comprising:
a plurality of reflection elements adjustable in phase and/or amplitude for supporting a plurality of reflection configurations, and the IRS is configured to:
operate with a plurality of reflection configurations for reflecting a plurality of pilot signals sent from the base station to the UE for probing the channel between the base station, IRS and the UE;
wherein the plurality of reflection configurations of the IRS comprises a first plurality of reflection configurations for estimating by the UE a channel covariance matrix CCM of the communication channel between the base station and the UE via the IRS, and a second plurality of reflection configurations for estimating by the UE the communication channel between the base station and the UE via the IRS.

18. The IRS of claim 17, wherein the IRS is further configured to operate with the plurality of reflection configurations for reflecting the plurality of pilot signals sent from the base station to the UE based on a codebook, wherein the codebook defines a mapping between a plurality of codes and the plurality of reflection configurations.

19. The IRS of claim 18, wherein the IRS is further configured to transmit, in response to a configuration information request from the UE, IRS configuration information to the UE for generating the codebook based on the IRS configuration information.

20. The IRS of claim 17, wherein the IRS is further configured to operate with the plurality of reflection configurations for reflecting the plurality of pilot signals sent from the base station for a plurality of time slots, wherein each time slot comprises one or more pilot slots for accommodating one or more of the plurality of pilot signals from the base station and one or more data slots for accommodating one or more of a plurality of data signals from the base station.
